(19) United States
(12) Patent Application Publication
(10) Pub. No.: US 2014/0298958 A1
(43) Pub. Date: Oct. 9, 2014

(54) TORQUE TOOL

(71) Applicant: William Farrell, Avenue, MD (US)

(72) Inventor: William Farrell, Avenue, MD (US)

(73) Assignee: The United of America as represented by the Secretary of the Navy, Patuxent River, MD (US)

(21) Appl. No.: 13/859,338

(22) Filed: Apr. 9, 2013

(51) Int. Cl. B25B 13/48; B25B 13/02

(52) U.S. Cl. CPC B25B 13/481; B25B 13/02
USPC 81/119

(57) ABSTRACT

A torque tool for torqueing a receptacle lug having at least one pair of opposite sides. The tool including a block portion, a pair of protrusions, a protruding annulus, a bore, and a receptor for accepting a torque drive. The protrusions are able to correspond to and engage any one pair of opposite sides of the receptacle lug. The protruding annulus is disposed on the same plane of the block portion as the pair of protrusions, and is disposed such that the annulus can act as a pilot for the receptacle lug. The bore passes through the same plane of the block portion where the protrusions and annulus are located. When the receptor for accepting a torque drive is actuated by a torque drive, the protrusions engage any two opposite sides of the receptacle and the receptacle is either loosened or tightened.

### STATEMENT OF GOVERNMENT INTEREST

The invention described herein may be manufactured and used by or for the Government of the United States of America for governmental purposes without payment of any royalties thereon or therefor.

### BACKGROUND

A military aircraft typically has a launch assembly for weapons or a rocket launcher. Typically the launch assembly is connected to an aircraft pylon via lugs. In particular, in the Fire Scout unmanned aircraft, the lugs are screwed into a lug receptacle, which is screwed into a threaded well in the hardback of the launch assembly. The hardback can defined, but without limitation, as the part of the launch assembly that bears the load of the entire assembly. Navy regulations require the lug receptacles to be screwed into the threaded well at 120 foot-pounds of torque.

Conventional tools, such as sockets and wrenches, are unable to be used on the lug receptacle due to the design of the launch assembly. The lug receptacle must be flush with the skin of the launch assembly and protruding hinges on the launch assembly do not provide enough clearance so that standard sockets or wrenches can envelop and turn the lug receptacle. Additionally, because of the location of the lug receptacle only two edges of the lug receptacle can be engaged at any given time.

### SUMMARY

The present invention is directed to a torque tool that meets the needs enumerated above and below.

The present invention is directed to a the torque tool which includes a block portion having at least one plane, a pair of protrusions, a protruding annulus, a bore, and a receptor for accepting a torque drive. The protrusions are disposed on opposite ends of the same plane of the block portion such that the protrusions are able to correspond to and engage any one pair of opposite sides of the multi-sided receptacle lug. The protruding annulus is disposed on the same plane of the block portion as the pair of protrusions. The annulus is further disposed such that the annulus can act as a pilot for the multi-sided receptacle lug. The bore passes through the same plane of the block portion where the protrusions and the annulus are located. The receptor accepts a torque drive such that when the torque drive is actuated the protrusions engage any two opposite sides of the multi-sided receptacle, and the multi-sided receptacle is either loosened or tightened to the threaded well.

It is a feature of the present invention to provide a torque tool that allows a lug receptacle on an aircraft to be torqued to a specific torque.

It is a feature of the present invention to provide a torque tool that can torque a lug receptacle that cannot be torqued by a standard socket or wrench.

It is a feature of the present invention to provide a torque tool that only needs to grab two edges of a lug receptacle in order to torque the lug receptacle.

### DRAWINGS

These and other features, aspects and advantages of the present invention will become better understood with reference to the following description and appended claims, and accompanying drawings wherein:

FIG. 1 is an exploded view of the relevant parts of the launch assembly;

FIG. 2 is a perspective view of an embodiment of the torque tool;

FIG. 3 is a bottom view of an embodiment of the torque tool;

FIG. 4 is a top view of an embodiment of the torque tool; and.

FIG. 5 is a cross sectional view of an embodiment of the torque tool.

### DESCRIPTION

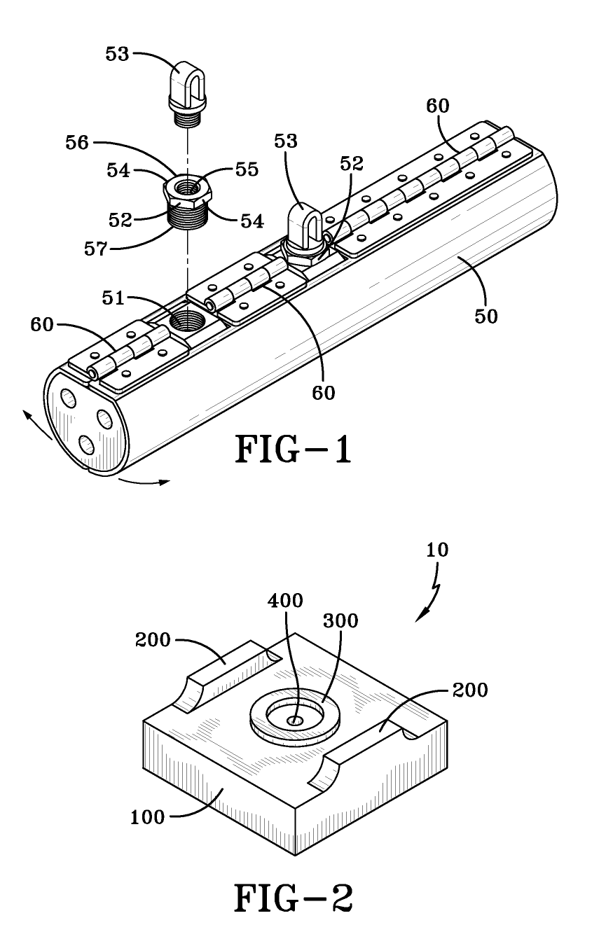

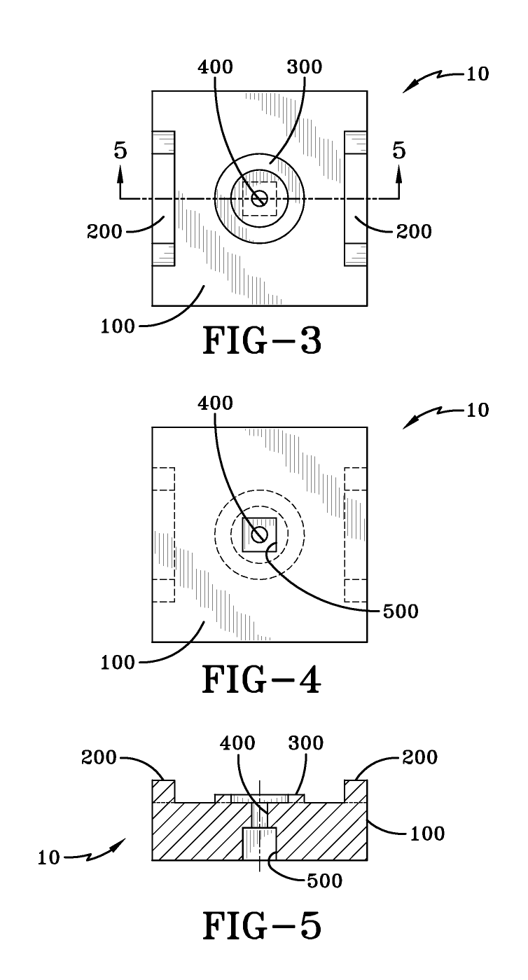

The preferred embodiments of the present invention are illustrated by way of example below and in FIGS. 1-5. As shown in FIG. 1, a launch assembly 50 includes a threaded well 51 that accepts a lug receptacle 52. The lug receptacle 52 includes a lug receptacle aperture 55 that is internally threaded and corresponds to a male threaded lug 53. The lug receptacle aperture 55 accepts the male threaded lug 53, which attaches to a pylon on an aircraft. The lug receptacle 52 also includes a multi-sided nut portion 56 and an external threaded portion 57 that corresponds to the threaded well 51. Hinges 60 on launch assembly 50 do not provide enough clearance so that standard sockets or wrenches can envelop and turn the lug receptacle 52 so that the external threaded portion 57 can be torqued into the threaded well 51. Therefore, the torque tool 10 is needed to torque the lug receptacle 52 into the threaded well 51. As seen in in FIGS. 2-5, the torque tool 10 includes a block portion 100 having at least one plane, a pair of protrusions 200, a protruding annulus 300, a bore 400, and a receptor 500 for accepting a torque drive. The pair of protrusions 200 are disposed on opposite ends of the same plane of the block portion 100 such that the protrusions are able to correspond to and engage any one pair of opposite sides 54 of the multi-sided nut portion 56 of the multi-sided receptacle lug 52. The protruding annulus 300 is disposed on the same plane of the block portion 100 as the pair of protrusions 200. The annulus 300 is further disposed such that the annulus can act as a pilot for the multi-sided receptacle lug 52. The bore 400 passes through the same plane of the block portion 100 where the protrusions 200 and the annulus 300 are located. The receptor 500 accepts a torque drive such that when the torque drive is actuated the protrusions 200 engage any two opposite sides 54 of the multi-sided receptacle 52 and the multi-sided lug receptacle 52 is either loosened or tightened to the threaded well 51.

In the description of the present invention, the invention will be discussed in an aircraft environment; however, this invention can be utilized for any type of application that requires use of a torque tool.

As shown in FIG. 5, the bore 400 and the receptor 500 are axially aligned. To be axially aligned the axis of both the bore 400 and the receptor 500 substantially form a straight line.

The torque tool 10 may be one machined piece and manufactured from any hard material. The preferred material is steel, particularly 17-4 stainless steel hardened at 180 ksi.

In operation, the torque tool 10 is placed on the lug receptacle 52 such that the protrusions 200 engage two opposite sides 54 of the multi-sided nut portion 56, and the annulus 300 is encircled by the multi-sided nut portion 54 (particularly by the lug receptacle aperture 55) such that the annulus 300 acts as a guide to the torque tool 10. A torque drive is then placed in the receptor 500. The torque drive is actuated causing the protrusions 200 to exert force on the opposite sides 54 of the multi-sided nut portion 56, which turns the lug receptacle 52, and either tightens or loosens the lug receptacle in relation to the threaded well.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A torque tool for torqueing a multi-sided receptacle lug having at least one pair of opposite sides, the tool comprising:
a block portion having at least one plane;
a pair of protrusions disposed on opposite ends of the same plane of the block portion such that the protrusions are able to correspond to and engage any one pair of opposite sides of the multi-sided receptacle lug;
a protruding annulus disposed on the same plane of the block portion as the pair of protrusions, the annulus further disposed such that the annulus can act as a pilot for the multi-sided receptacle lug;
a bore passing through the same plane of the block portion where the protrusions and annulus are located; and,
a receptor for accepting a torque drive such that when the torque drive is actuated the pair of protrusions engage any two opposite sides of the multi-sided receptacle and the multi-sided receptacle is either loosened or tightened.

2. The torque tool of claim 1, wherein the receptor is axially aligned to the bore.

3. The torque tool of claim 2, wherein the torque tool is manufactured from one piece of material.
